(19) United States
(12) Patent Application Publication
(10) Pub. No.: US 2008/0085815 A1
(43) Pub. Date: Apr. 10, 2008

(54) Method For Adapting An Operating Mode Of An Automatic Variable Speed Transmission

(75) Inventors: Matthias Winkel, Weingarten (DE); Bertram Wengert, Markdorf (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN, FRIEDRICHSHAFEN (DE)

(21) Appl. No.: 11/813,780

(22) PCT Filed: Dec. 2, 2005
(86) PCT No.: PCT/EP05/12918

§ 371 Date: Jul. 12, 2007

(30) Foreign Application Priority Data
Jan. 13, 2005 (DE) 10 2005 001 507.7

(51) Int. Cl. F16H 61/02; B60W 10/00

(52) U.S. Cl. 477/78

(57) ABSTRACT

A method for adapting an operating mode of an automatic variable speed transmission for a vehicle having an engine (1), whose torque is transferred from a clutch (2) to an automatic variable speed transmission (3), where the target rotational speed of the variable speed transmission and a corresponding gear (x, x-1, x-2) is selected in such a way depending upon a vehicle acceleration and an available engine power that no further change of the gear is required for a predeterminable time period when the vehicle acceleration remains the same after the selected gear has been applied.

This application is a national stage completion of PCT/EP2005/012918 filed Dec. 2, 2005, which claims priority from German Application Serial No. 10 2005 001 507.7 filed Jan. 13, 2005.

### FIELD OF THE INVENTION

The invention concerns a method or adapting a mode of operation of an automatic variable speed transmission.

### BACKGROUND OF THE INVENTION

It is known that automatically shifting step-by-step variable speed transmissions for vehicles, shift automatically within the range of the available gears depending upon a load condition, such as the pressure applied to the accelerator. It is also known that specific gears of a step-by-step variable speed transmission can be excluded by the driver from the shifting sequence by pressing a key. When traveling downhill, the highest gear can be locked so that the transmission shifts only into a reduced number of gears. Manual limitation of the automatic gearshifts of the transmission is allowed for transmissions having few gears. In automatic step-by-step variable speed transmissions having a multitude of gears, upper and lower gears can be similarly excluded from the shifting sequence by manually actuating a switch. Since automatic variable speed transmissions having 12 or 16 gears are predominantly used in utility vehicles, a limitation of the allowable gears such as this can be advantageous, for example, when driving with a partial load.

It is state of the art to exclude a few gears from the automatic shifting sequence within the entire gear ratio range of the transmission when it is desired to save fuel. For this purpose, a multitude of parameters can be taken into consideration, such as the load requirement, the engine rotational speed, the engine power, the temperature of the transmission oil, the air pressure, for example. When controlling the shifting sequence in this manner, a multitude of characteristic curves should be taken into consideration in a transmission control device and a complex calibration of the parameter values among each other is required.

The practice has shown that with transmission control devices, such as these, a comparatively high shifting frequency can be seen. If a high acceleration of the vehicle is requested, for example, by stepping hard on the accelerator (kickdown), a downshift of the variable speed transmission is started by way of a kickdown switch. With this, a higher engine rotational speed or engine power and in this way a higher acceleration capacity of the vehicle, are made available.

It is also possible to engage a gear, with which the maximum rotational speed is set, after a short time so that the next highest gear must be engaged. Consequently, it can occur that it is shifted from the tenth gear directly into the eighth gear; the eighth gear remains engaged for only a short time, and the ninth gear is engaged immediately thereafter. The eighth gear can, indeed, be temporarily the “correct” gear, due to the comparatively high transferable engine torque. However, if the maximum allowable rotational speed is reached after one or two seconds, a higher gear must be engaged even if it is engaged to a reduced output torque and the desired acceleration is not reached. The short-term frequent shifting leads overall to interruptions in tractional force interruptions, during which a lower overall acceleration of the vehicle is reached than would be the case if the tenth gear were directly shifted into the ninth gear. It was also discovered that it can even be practical, depending on the driving situation, to not even change the gear so that no tractional force interruption is produced.

For this reason, it is an object of the invention to create a method for adapting a mode of operation of an automatic variable speed transmission for a vehicle so that a reduced shifting frequency with lower mechanical and control effort is possible depending upon the driving situation.

### SUMMARY OF THE INVENTION

The invention is based on the realization that the described object can be attained when not only the temporarily advantageous gear of a variable speed transmission is taken into consideration as target gear in the control of the gear changing procedures, but also the expected subsequent gear shifting procedure is taken into consideration when this target gear is determined.

Accordingly, the invention is based on a method for adapting a mode of operation of an automatic variable speed transmission for a vehicle having an engine whose torque is transferred by a clutch to the variable speed transmission. According to the method, a target rotational speed of the transmission and a corresponding gear are selected in such a way depending upon a vehicle acceleration and an available engine power that no further change of the gear is required for a predeterminable time period when the vehicle acceleration remains the same after the selected gear has been applied.

A predetermined time period such as this can amount to 1 to 2 seconds, but also greater time periods can be comprised by the invention.

Based on the vehicle acceleration is thus determined a target rotational speed from which can be derived such a suitable gear.

In addition, a low target rotational speed can be preferably selected when there is a high vehicle acceleration. This is advantageous, since a frequent downshifting and repeated upshifting can be avoided in this way.

A high target rotational speed can also be preferably selected when there is a low vehicle acceleration. This is advantageous, because when there is a low vehicle acceleration, it cannot be expected that the maximum rotational speed limit will be reached with the selected gear directly after engaging the gear so that an upshifting would be imperatively required. With a low acceleration can thus be engaged the gear that can be used at that particular moment.

In addition, a maximum possible vehicle acceleration can also be preferably determined at maximum torque, whereupon the target rotational speed with the corresponding gear is selected on the basis thereof. This is advantageous when the vehicle is operated with a vehicle acceleration, which still does not correspond to the maximum possible vehicle acceleration.

The target rotational speed can also be preferably selected depending upon the vehicle mass, the driving resistance, the transmission ratio, a program switch and/or the transmission oil temperature. This is advantageous, since a finely stepped adaptation of the variable speed transmission to the external conditions can be achieved in this way.

BRIEF DESCRIPTION OF THE DRAWINGS

The invention will now be described, by way of example, with reference to the accompanying drawings in which:

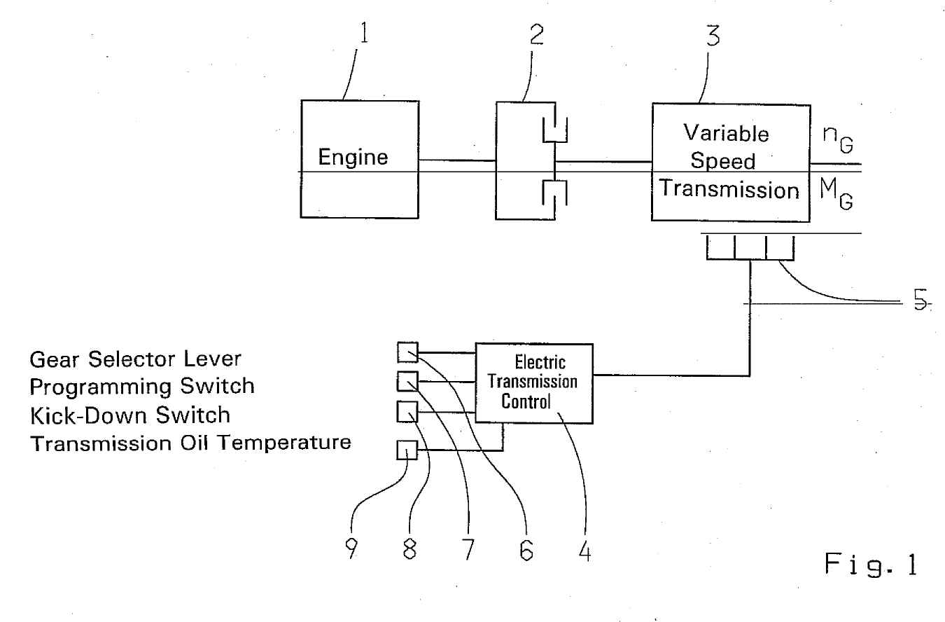

FIG. 1 shows a schematic representation of an electronic transmission control, and

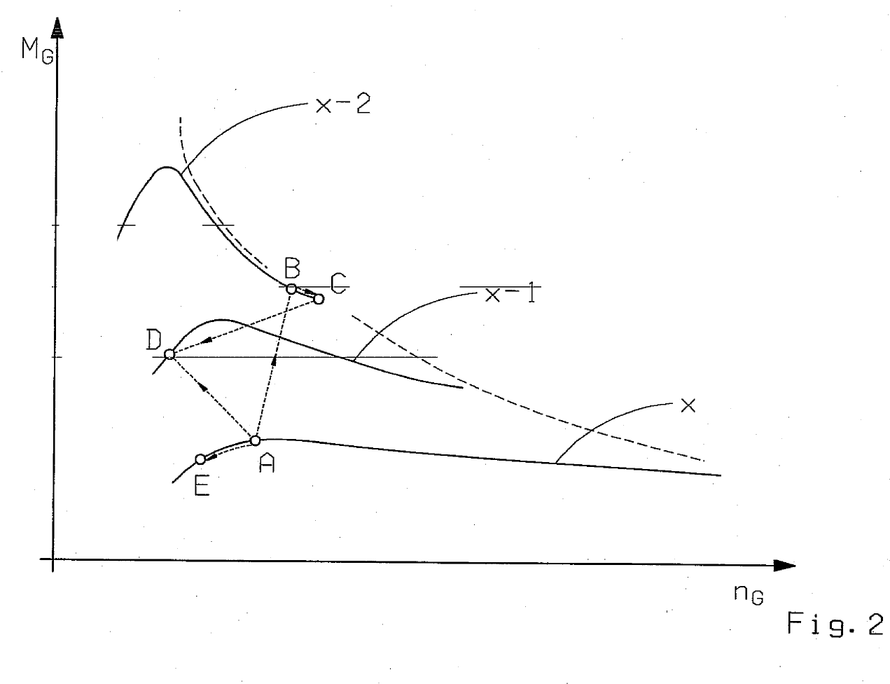

FIG. 2 shows a diagram with schematic representation of transmission output characteristics.

### DETAILED DESCRIPTION OF THE INVENTION

In FIG. 1 is shown a schematic representation of a power train with an electronic transmission control 4. Torque is generally transferred by way of a motor 1, usually an internal combustion engine, to a clutch 2, which forwards this torque to an automatic variable speed transmission 3. The variable speed transmission 3 has the task of converting the engine torque and transferring it to an axle drive, making it possible to idle the engine with the vehicle standing still and making it possible to reverse the direction of rotation for driving in reverse. The design, according to the propulsion technology of the variable speed transmission 3, which includes a transmission output shaft, the axle drive, axle driving shafts and vehicle wheels, is known to the persons skilled in the art and is not depicted in detail herein.

In an automatically shifting transmission 3, the planetary gears contained therein, as well as the multiple disk clutches and gear brakes, are shifted by way of magnetic valves 5. The magnetic values 5 are controlled by the electronic transmission control 4, which receives shift and sensor signals. These signals may include, for example, a gear selector lever position 6, where the desired driving direction and an eventual limited number of available gears is determined. A further signal 7 for the electronic transmission control is derived from the position of a program switch, with which a sport program, a winter program or manual shifting can be chosen. In addition, the transmission control takes into consideration a signal 8 of a kickdown switch, with which high vehicle speed, desired by the driver, is signaled. A further input variable is a transmission oil temperature 9. If it exceeds a specific critical value, then the shifting is carried out only at a higher engine rotational speed, whereby the amount of recycled oil is increased.

An example of a shifting sequence controlled by the electronic transmission control 4 can be seen in FIG. 2. In FIG. 2 are depicted transmission output characteristics, plotted in a coordinate system with an abscissa as transmission output rotational speed n_{G} and an ordinate as transmission output torque M_{G}. Also plotted in FIG. 2 are three characteristic curves, which are identified with x, x-1 and x-2. They represent the attainable torque depending upon the rotational speed of a selected gear x, x-1 and x-2. In FIG. 2, the gear x is the gear with the highest gear ratio level. The gear x-1 is a gear that is lower than the gear x by one or several levels. Similarly, the gear x-2 is a gear that is lower than the gear x-1 by one or several levels.

In the relatively low gear x-2 shown herein, a high torque is attained within an initial rotational speed range of the transmission, which diminishes with increasing rotational speed. The characteristic curve for the gear x-1 runs mainly along the characteristic curve of the gear x-2 where, instead a low torque can be reached, while the available rotational speed range is greater than with the gear x-2. The gear x-1 can be operated at even higher rotational speeds than the gear x-2.

The gear x is the highest gear represented in FIG. 2, where a relatively low torque is achieved. In contrast with the gears x-1 and x-2, a very high rotational speed can be attained with the gear x. If the transmission in the gear x is operated with a rotational speed corresponding to the point A, and if the transmission control shows that acceleration is required, the gear x-2 is engaged from the operating point A to the operating point B. In the gear x-2, higher torque and thus higher acceleration can be reached, however, while a practical increase of the rotational speeds is considerably limited due to the dropping curve progression. The maximum allowable rotational speed is reached at point C in the gear x-2 so that a higher gear, in this case x-1, must be engaged at the latest at point C. This is represented with the connecting line from C to D in FIG. 2, where D is a point on the characteristic curve, which belongs to the gear x-1. In this way, the shifting is carried out from an operating point A to the operating point D, via the operating points B and C.

When a higher acceleration is requested, the gear x-2 engages eventually for only one or two seconds, when seen in retrospect it should not have been necessary to engage the gear x-2. For this reason, the theoretically possible and temporarily “correct” gear x-2 is not engaged when there is a higher acceleration, but the gear x-1 is engaged, which is at a higher level. With this, the detour, via the operating points B and C, is avoided so that a shift can be made directly from the operating point A to the operating point D. With this comes only a very short-term tractional force interruption, since only one shifting procedure is carried out.

In FIG. 2, it can be seen that an increase of the torque occurs within a limited range from the operating point D with increasing rotational speed so that, in a first approximation, an increase of the vehicle acceleration takes place. When there is a request for a high vehicle acceleration, shifting occurs from the operating point A to the operating point D, which has a low rotational speed.

The transmission, according to the invention, is controlled differently, instead when only a low acceleration is requested. With a low acceleration, it cannot be expected that the maximum rotational speed will be reached directly after shifting into a lower gear and an upshift into a higher gear must take place. With a low acceleration a gear is thus selected that is operated with a high rotational speed.

The selection of the gears depending upon the vehicle acceleration, as described above, can lead in specific situations to unsatisfactory results. If the acceleration is zero or if it is even negative (for example, during braking), there is initially no indication that a higher or lower gear should be engaged. With an engaged gear x, if the operating point A is displaced to the operating point E, it is possible that the rotational speed from the operating point E to the operating point A increases with a subsequent slight acceleration before a downshift can take place. This is mainly caused by the fact that the full torque has still not been reached at the operating point E. In such a situation, a maximum possible vehicle acceleration at maximum torque can be determined according to the invention, where the target rotational speed with the corresponding gear can be derived therefrom.

A further enhancement of the adaptation interface can be achieved by way of a consideration of further parameters. To these belong the vehicle mass. With an unloaded or only partially loaded vehicle a target rotational speed can be predetermined that is different than with a fully loaded vehicle. The driving resistance can, likewise, be taken into consideration by the control. With regard to the driving resistance, the road resistance, the climbing resistance and the air resistance should be mentioned. The target rotational speed can be adapted depending on the height of this resistance, taking into consideration the vehicle acceleration.

Reference Numerals

1 motor/engine
2 clutch
3 variable speed transmission
4 electric transmission control
5 magnetic valves
6 gear selector lever
7 programming switch signal
8 kickdown switch signal
9 transmission oil temperature
M_{G} transmission output torque
n_{G} transmission output rotational speed
x gear

1-5. (canceled)

6. A method of adapting an operational mode of an automatic variable speed transmission of a vehicle having an engine (1) whose torque is transferred from a clutch (2) to the automatic variable speed transmission (3), the method comprising the steps of:
selecting a target rotational speed of the variable speed transmission (3) and a corresponding gear (x, x-1, X-2), in dependence upon a vehicle acceleration and an available engine power, such that no further change of the gear is required for a predeterminable time period, and when the vehicle acceleration remains the same after the selected gear has been applied.

7. The method according to claim 6, further comprising the step of, when the vehicle acceleration is relatively high, selecting a low target rotational speed.

8. The method according to claim 6, further comprising the step of, when the vehicle acceleration is relatively low, selecting a high target rotational speed.

9. The method according to claim 6, further comprising the step of determining a maximum possible vehicle acceleration at maximum torque, whereupon the target rotational speed with the corresponding gear is selected on the basis thereof.

10. The method according to claim 6, further comprising the step of selecting the target rotational speed dependent upon at least one of a vehicle mass, a driving resistance, a transmission ratio, a program switch, and a transmission oil temperature.

11. A method of adjusting a mode of operating an automatic variable speed transmission of a vehicle with an engine (1) for producing torque, which is transmitted, via a clutch (2), to the automatic transmission (3), the method comprising the steps of:
providing the vehicle with at least a gear selector lever sensor to detect a gear lever selector position, a programming switch to detect a current driving program, a kick-down switch to detect a driver's desire for increasing a vehicles speed and a transmission oil temperature sensor to detect a temperature of transmission oil, each sensor communicating with an electric transmission control;
controlling the automatic transmission according to the mode of operating the automatic variable speed transmission;
transmitting at least one of a signal of the gear lever selector position, a signal of the current driving program, a signal of the driver's desire for increasing the vehicles speed and a signal of the temperature of the transmission oil from the respective sensor to the electric transmission control; and
adjusting the mode of operating the automatic variable speed transmission by selecting target rotational speed of the variable speed transmission (3) and a gear (x, x-1, x-2), with consideration being given to signal of the gear lever selector position, the signal of the current driving program, the signal of the driver's desire for increasing the speed of the vehicle and the signal of the temperature of the transmission oil, such that depending on, a vehicle acceleration and an available engine power, a further change of gear is prevented for a predeterminable time period if the vehicle acceleration remains the same after a selected gear has been engaged.
